(19) United States
(12) Patent Application Publication
(10) Pub. No.: US 2026/0223915 A1
(43) Pub. Date: Aug. 6, 2026

(54) Aerosol Generating System, Article and Device

(71) Applicant: JT International SA, Geneva (CH)

(72) Inventors: Alec Wright, Guildford (GB); Grzegorz Aleksander Pilatowicz, Grens (CH)

(73) Assignee: JT International SA, Geneva (CH)

(21) Appl. No.: 19/146,386

(22) PCT Filed: Jan. 3, 2024
(86) PCT No.: PCT/EP2024/050101

§ 371 Date: Jul. 8, 2025

(30) Foreign Application Priority Data
Jan. 11, 2023 (EP) 23151083.5

(51) Int. Cl. A24D 1/02; A24D 1/20; A24F 40/20; A24F 40/46; H05B 3/03

(52) U.S. Cl. CPC A24D 1/02; A24D 1/20; A24F 40/20; A24F 40/46; H05B 3/03

(57) ABSTRACT

An aerosol generating system is described which includes an aerosol generating article (or consumable) and an aerosol generating device. The aerosol generating article includes aerosol generating material with a first outer surface and a second outer surface substantially opposite the first outer surface, a first electrically non-conductive layer adjacent the first outer surface, and a second electrically non-conductive layer adjacent the second outer surface. The aerosol generating device includes a first electrode and a second electrode. When the aerosol generating article is received in the device, in use, the first electrode is positioned adjacent the first electrically non-conductive layer and a second electrode is positioned adjacent the second electrically non-conductive layer. The first electrically non-conductive layer has an inner surface and an outer surface. The aerosol generating article includes a first electrically conductive layer positioned between the first outer surface of the aerosol generating material and the inner surface of the first electrically non-conductive layer.

### TECHNICAL FIELD

The present disclosure relates generally to an aerosol generating article, and in particular to an aerosol generating article adapted to be received in an aerosol generating device for generating an aerosol for inhalation by a user. The present disclosure also relates to an aerosol generating system comprising the aerosol generating article and the aerosol generating device.

The present disclosure is particularly applicable to a portable (hand-held) aerosol generating device.

### TECHNICAL BACKGROUND

Devices which heat, rather than burn, an aerosol generating material to produce an aerosol for inhalation have become popular with consumers in recent years. A commonly available reduced-risk or modified-risk device is the heated material aerosol generating device, or so-called heat-not-burn device. Devices of this type generate an aerosol or vapour by heating an aerosol generating material to a temperature typically in the range 150° C. to 300° C. This temperature range is quite low compared to an ordinary cigarette. Heating the aerosol generating material to a temperature within this range, without burning or combusting the aerosol generating material, generates a vapour which typically cools and condenses to form an aerosol for inhalation by a user of the device.

Such devices may use one of a number of different approaches to provide heat to the aerosol generating material. One approach may be designed to heat an electrically conductive aerosol generating material, for example a tobacco material that has been doped with an electrically conductive material such as a carbon-based material to make it electrically conductive, by applying an electric current to the aerosol generating material. The aerosol generating material is therefore heated directly by the electric current that flows through the aerosol generating material (Joule heating) instead of being heated indirectly by an external heater or by one or more susceptors located outside of the aerosol generating material in the case of an induction heating system, for example. The aerosol generating material may be part of an aerosol generating article which the user inserts into the device in use. Heating the aerosol generating material normally requires at least part of the aerosol generating material to be exposed on a surface of the aerosol generating article so that an electrical connection may be made with the device. This may not be acceptable to the user, for example because of the risk that their fingers may come into contact with the exposed aerosol generating material, or because some of the aerosol generating material may escape from the article. Embodiments of the present disclosure therefore seek to solve this problem by providing alternative ways of heating the aerosol generating material by constructing an aerosol generating system as a capacitor and applying an electric field across the aerosol generating material. Such an arrangement may provide direct heating even when the electrically conductive aerosol generating material is surrounded by an electrically non-conductive wrapper such as a paper wrapper, for example. The present disclosure also provides an embodiment where the aerosol generating material is electrically non-conductive, i.e., where the aerosol generating material is not doped with an electrically conductive material.

### SUMMARY OF THE DISCLOSURE

According to a first aspect of the present disclosure, there is provided an aerosol generating system comprising:
aerosol generating material with a first outer surface and a second outer surface substantially opposite the first outer surface;
a first electrically non-conductive layer adjacent the first outer surface;
a second electrically non-conductive layer adjacent the second outer surface;
a first electrode adjacent the first electrically non-conductive layer; and
a second electrode adjacent the second electrically non-conductive layer.

The aerosol generating material and the first and second electrically non-conductive layers may be part of an aerosol generating article (or consumable).

The first and second electrodes may be part of an aerosol generating device adapted to receive, in use, the aerosol generating article. When the aerosol generating article is received in the aerosol generating device, for example in an aerosol generating space or heating chamber of the device, the first electrode will be positioned adjacent the first electrically non-conductive layer and the second electrode will be positioned adjacent the second electrically non-conductive layer. It will be readily understood from the following description that this does not preclude one or more additional layers from being located between the first electrode and the first electrically non-conductive layer or between the second electrically non-conductive layer and the second electrode. Such additional layer(s) may be part of the aerosol generating article, for example.

The first and second electrodes may be substantially planar and may define a pair of electrically conductive parallel capacitor plates that are separated by a dielectric that includes at least the first and second electrically non-conductive layers. In some arrangements, the dielectric will also include the aerosol generating material if it is formed from an electrically non-conductive material. The aerosol generating system is therefore constructed generally as a capacitor. The first electrode may be connected to a first terminal (e.g., a positive terminal) and the second electrode may be connected to a second terminal (e.g., a negative terminal). When a voltage is applied across the first and second terminals to charge the capacitor, for example if the aerosol generating device further comprises a circuit electrically connected between the first and second terminals with a power source (e.g., a battery), a net positive charge will collect on the positive electrode (e.g., the first electrode) and a net negative charge will collect on the negative electrode (e.g., the second electrode). An electric field is generated between the first and second electrodes. The capacitor may be charged until its voltage value is substantially equal to the voltage of the power source. If the capacitor is fully charged, the current will stop flowing in the circuit. The capacitor may be discharged, e.g., through a resistor. As described in more detail below, charging and discharging the capacitor heats the aerosol generating material to generate an aerosol for inhalation by a user.

The circuit may further comprise a switching device (e.g., one or more switches). The switching device may be closed to charge the capacitor and opened to discharge the capacitor. The one or more switches may be semiconductor switching devices. The one or more switches may be opened or closed (or switched on and off) by a controller.

The first electrode may have a surface area substantially the same as the surface area of the first outer surface of the aerosol generating material or the surface area of an outer surface of the first electrically non-conductive layer. The second electrode may have a surface area substantially the same as the surface area of the second outer surface of the aerosol generating material or the surface area of an outer surface of the second electrically non-conductive layer. It will be understood that the capacitance of a parallel plate capacitor is proportional to the area of the smallest of the first and second electrodes and inversely proportional to the distance or separation between them. The aerosol generating material may be substantially cuboid and the first and second outer surfaces of the aerosol generating material may be the surfaces of the cuboid with the largest surface area so as to maximise the capacitance. Maximising the capacitance may improve the efficiency of aerosol generation. In other arrangements, the first electrode may have a surface area that is larger or smaller than the surface area of the first outer surface of the aerosol generating material or the outer surface of the first electrically non-conductive layer, and the second electrode may have a surface area that is larger or smaller than the surface area of the second outer surface of the aerosol generating material or the surface area of the outer surface of the second electrically non-conductive layer, for example.

The first and second electrodes may be formed from any suitable electrically conductive material such as aluminium, for example.

The aerosol generating material may comprise a plant derived material, and in particular may comprise a tobacco material.

The aerosol generating material may be an electrically non-conductive material or it may be an electrically conductive material and may further comprise a carbon-based material such as charcoal, for example, or a metal such as aluminium. In particular, the aerosol generating material may comprise an electrically non-conductive material such as a plant derived material or a tobacco material as a substrate that is then doped with an electrically conductive material such as the carbon-based material or metal particles to make it electrically conductive.

When heated, the aerosol generating material may release one or more volatile compounds. The volatile compounds may include nicotine or flavour compounds such as tobacco or other flavouring.

If the aerosol generating material is an electrically conductive material, the first electrically non-conductive layer functions as a first dielectric between the first electrode and the aerosol generating material. The second electrically non-conductive layer functions as a second dielectric between the aerosol generating material and the second electrode. If the first electrode is a positive electrode and the second electrode is a negative electrode, for example, when a voltage is applied across the first and second terminals to charge the capacitor, the electric field that is generated between the first and second electrodes will cause an electric current to flow through the aerosol generating material. A net negative charge will collect on the first outer surface of the aerosol generating material facing the first electrode and a net positive charge will collect on the second outer surface of the aerosol generating material facing the second electrode. When the capacitor is discharged, an electric current will flow through the aerosol generating material in the opposite direction. Because of the internal resistance of the aerosol generating material, the electric current that flows through the aerosol generating material when the capacitor is charged and discharged provides direct heating of the aerosol generating material by Joule heating. When the capacitor is charged, the first and second electrically non-conductive layers are polarised by the electric field such that positive charges within the layers are displaced slightly in the direction of the electric field and negative charges are displaced slightly in the direction opposite to the electric field. The polarisation is released when the capacitor is discharged.

If the aerosol generating material is an electrically non-conductive material, the aerosol generating material and the first and second electrically non-conductive layers function as a dielectric between the first and second electrodes. Charging and discharging the capacitor dissipates heat in the first and second electrodes, which heats the adjacent aerosol generating material. When the capacitor is charged, i.e., when an electric field is generated between the first and second electrodes, an electric current does not flow through the aerosol generating material as it does in case of the electrically conductive aerosol generating material described above. Instead, the aerosol generating material is polarised such that positive charges within the aerosol generating material (and the first and second electrically non-conductive layers) are displaced slightly in the direction of the electric field, and the negative charges are displaced slightly in the direction opposite to the electric field. The polarisation is released when the capacitor is discharged and the charges may revert to their original positions. The moving positive and negative charges interact with the internal resistance of the aerosol generating material to provide direct heating of the aerosol generating material when the capacitor is charged and discharged.

In both arrangements, direct heating is provided without having to expose part of the aerosol generating material. The aerosol generating material may therefore be completely surrounded by a wrapper such as a paper wrapper, which may form the first and second electrically non-conductive layers. There is no risk that the fingers of the user will come into contact with exposed aerosol generating material, nor that some of the aerosol generating material will escape from the aerosol generating article.

The first electrically non-conductive layer may have an inner surface and an outer surface. The inner surface will face the aerosol generating material and the outer surface will face the first electrode.

The second electrically non-conductive layer may have an inner surface and an outer surface. The inner surface will face the aerosol generating material and the outer surface will face the second electrode.

In one arrangement, the aerosol generating article may further comprise a first electrically conductive layer (e.g., a first aluminium layer) positioned between the outer surface of the first electrically non-conductive layer and the first electrode. Similarly, the aerosol generating article may further comprise a second electrically conductive layer (e.g., a second aluminium layer) positioned between the outer surface of the second electrically non-conductive layer and the second electrode. The first electrically conductive layer may be in electrical contact with the first electrode and the second electrically conductive layer may be in electrical contact with the second electrode when the aerosol generating article is received in the aerosol generating device. The first and second electrically conductive layers may provide increased heating of the aerosol generating material when the capacitor is charged and discharged. Because the first and second electrically conductive layers may function as electrodes that directly face the aerosol generating material they may increase the available capacitance. If the first electrode is a positive electrode and the second electrode is a negative electrode, for example, when a voltage is applied across the first and second terminals to charge the capacitor, a net positive charge will collect on the first electrically conductive layer and a net negative charge will collect on the second electrically conductive layer. A first electrode assembly (e.g., a positive electrode assembly) may comprise the first electrode and the first electrically conductive layer, and a second electrode assembly (e.g., a negative electrode assembly) may comprise the second electrode and the second electrically conductive layer, for example.

If the aerosol generating material is an electrically non-conductive material, the aerosol generating material and the first and second electrically non-conductive layers function as a dielectric between the first and second electrode assemblies. Charging and discharging the capacitor dissipates heat in the first and second electrodes and the first and second electrically conductive layers, which heats the adjacent aerosol generating material. The aerosol generating material is also heated by the interaction of the moving positive and negative charges with the internal resistance of the aerosol generating material as described above when the aerosol generating material (and the first and second electrically non-conductive layers) are polarised by the electric field and when the polarisation is released.

If the aerosol generating material is an electrically conductive material, the first electrically non-conductive layer functions as a first dielectric between the first electrode assembly and the aerosol generating material. The second electrically non-conductive layer functions as a second dielectric between the aerosol generating material and the second electrode assembly. If the first electrode assembly is a positive electrode assembly and the second electrode assembly is a negative electrode assembly, for example, when a voltage is applied across the first and second terminals to charge the capacitor, the electric field that is generated between the first and second electrode assemblies will cause an electric current to flow through the aerosol generating material. In particular, once a voltage is applied across the first and second terminals, the first and second electrically non-conductive layers are polarised. Such polarisation of the first and second electrically non-conductive layers causes an electric field to be generated across the aerosol generating material, which in turn causes an electric current to flow through the aerosol generating material. A net negative charge will collect on the first outer surface of the aerosol generating material facing the first electrode/electrically conductive layer and a net positive charge will collect on the second outer surface of the aerosol generating material facing the second electrode/electrically conductive layer. When the capacitor is discharged, an electric current will flow through the aerosol generating material in the opposite direction. Because of the internal resistance of the aerosol generating material, the electric current that flows through the aerosol generating material when the capacitor is charged and discharged provides direct heating of the aerosol generating material by Joule heating.

A surface area of the first electrically conductive layer may be larger than the surface area of the outer surface of the first electrically non-conductive layer (or the first outer surface of the aerosol generating material) and/or a surface area of the second electrically conductive layer may be larger than the surface area of the outer surface of the second electrically non-conductive layer (or the second outer surface of the aerosol generating material). Making the first and/or second electrically conductive layers slightly larger than the corresponding outer surfaces of the electrically non-conductive layers or the aerosol generating material may increase available capacitance while also accommodating manufacturing tolerances.

In another arrangement, the aerosol generating article may further comprise a first electrically conductive layer (e.g., a first aluminium layer) positioned between the first outer surface of the aerosol generating material and the inner surface of the first electrically non-conductive layer. Similarly, the aerosol generating article may further comprise a second electrically conductive layer (e.g., a second aluminium layer) positioned between the second outer surface of the aerosol generating material and the inner surface of the second electrically non-conductive layer. In this arrangement, the first and second electrically conductive layers may be positioned within a wrapper such as a paper wrapper, for example, which may make the aerosol generating article more suitable for the user. For example, the user does not need to directly touch the first and second electrically conductive layers and so any electrical interaction with the user (e.g., static electricity shock) is avoided. The first and second electrically conductive layers are also protected by the wrapper. The wrapper may prevent the first and/or second electrically conductive layers from being damaged or becoming dirty, which damage or dirt may result in a reduction in the available capacitance. The first and second electrically non-conductive layers may be defined by parts of the wrapper as described in more detail below.

If the aerosol generating material is an electrically non-conductive material, the first electrically non-conductive layer functions as a first dielectric between the first electrode and the first electrically conductive layer. The second electrically non-conductive layer functions as a second dielectric between the second electrically conductive layer and the second electrode. The aerosol generating material functions as a third dielectric between the first and second electrically conductive layers. If the first electrode is a positive electrode and the second electrode is a negative electrode, for example, when a voltage is applied across the first and second terminals to charge the capacitor, the electric field that is generated between the first and second electrodes will cause polarisation of the aerosol generating material. In particular, once a voltage is applied across the first and second terminals, the first and second electrically non-conductive layers are polarised. The first and second electrically non-conductive layers charge the first and second electrically conductive layers, which then function as electrodes that directly face the aerosol generating material. The aerosol generating material is then polarised by the first and second electrically conductive layers. A net negative charge will collect on the outer surface of the first electrically conductive layer facing the first electrode and a net positive charge will collect on the inner surface of the first electrically conductive layer facing the aerosol generating material. A net negative charge will collect on the inner surface of the second electrically conductive layer facing the aerosol generating material and a net positive charge will collect on the outer surface of the second electrically conductive layer facing the second electrode. When the capacitor is discharged, polarisation of the aerosol generating material is released. Charging and discharging the capacitor dissipates heat in the first and second electrodes and the first and second electrically conductive layers, which heats the adjacent aerosol generating material. The aerosol generating material is also heated by the interaction of the moving positive and negative charges with the internal resistance of the aerosol generating material as described above when the aerosol generating material (and the first and second electrically non-conductive layers) are polarised by the electric field and when the polarisation is released.

If the aerosol generating material is an electrically conductive material, the first electrically non-conductive layer functions as a first dielectric between the first electrode and the first electrically conductive layer. The second electrically non-conductive layer functions as a second dielectric between the second electrically conductive layer and the second electrode. The first and second electrically conductive layers are preferably in electrical contact with the aerosol generating material and they may function together as an electrically conductive layer between the first and second electrically non-conductive layers. If the first electrode is a positive electrode and the second electrode is a negative electrode, for example, when a voltage is applied across the first and second terminals to charge the capacitor, the electric field that is generated between the first and second electrodes will cause an electric current to flow through the first and second electrically conductive layers and the aerosol generating material, which provides direct heating of the aerosol generating material by Joule heating. In particular, once a voltage is applied across the first and second terminals, the first and second electrically non-conductive layers are polarised. The first and second electrically non-conductive layers charge the first and second electrically conductive layers, which then function as electrodes that directly face the aerosol generating material and apply an electric field across the aerosol generating material. A net negative charge will collect on the outer surface of the first electrically conductive layer facing the first electrode and a net positive charge will collect on the outer surface of the second electrically conductive layer facing the second electrode. When the capacitor is discharged, an electric current will flow through the first and second electrically conductive layers and the aerosol generating material in the opposite direction.

The aerosol generating material may be part of an aerosol precursor section of the aerosol generating article. The aerosol generating article may further comprise a cooling section (or filter section) at a proximal end. The first and second electrodes preferably do not extend over or overlap with the cooling section when the article is received in the device. In other words, the cooling section is preferably positioned outside the space defined between the first and second electrodes when the article is received in the device. The cooling section may comprise cellulose acetate fibres, for example. The cooling section may constitute a mouthpiece filter. One or more vapour collection regions, cooling regions, and other structures may also be included in some designs. The vapour cooling region may advantageously allow the vapour to cool and condense to form an aerosol with suitable characteristics for inhalation by a user, for example through the filter segment. In general terms, a vapour is a substance in the gas phase at a temperature lower than its critical temperature, which means that the vapour may be condensed to a liquid by increasing its pressure without reducing the temperature, whereas an aerosol is a suspension of fine solid particles or liquid droplets, in air or another gas. It should, however, be noted that the terms ‘aerosol’ and ‘vapour’ may be used interchangeably in this specification.

The first electrically non-conductive layer may have a surface area substantially the same as the surface area of the first outer surface of the aerosol generating material.

The second electrically non-conductive layer may have a surface area substantially the same as the surface area of the second outer surface of the aerosol generating material.

The first and second electrically non-conductive layers may be formed by a wrapper (e.g., a paper wrapper) that extends substantially around the aerosol generating material. In this arrangement, it will be readily understood that the first electrically non-conductive layer is that part of the wrapper that is adjacent the first outer surface of the aerosol generating material and the second electrically non-conductive layer is that part of the wrapper that is adjacent the second outer surface of the aerosol generating material. The wrapper may extend around the other outer surfaces of the aerosol generating material and may substantially surround the aerosol precursor section and optionally also the cooling section of the aerosol generating article. It is generally preferred that at least the aerosol generating material is completely surrounded by the paper wrapper so that none of the aerosol generating material is exposed.

According to a second aspect of the present disclosure, there is provided an aerosol generating article comprising:
aerosol generating material (e.g., an electrically non-conductive or electrically conductive material—see above) with a first outer surface and a second outer surface opposite the first outer surface; and
an electrically non-conductive wrapper that extends substantially around the aerosol generating material and defines a first electrically non-conductive layer adjacent the first outer surface and a second electrically non-conductive layer adjacent the second outer surface.

According to a third aspect of the present disclosure, there is provided an aerosol generating device adapted to receive, in use, the aerosol generating article described above. The device comprises a first electrode (e.g., first capacitor plate) adjacent the first electrically non-conductive layer in use and a second electrode (e.g., second capacitor plate) adjacent the second electrically non-conductive layer in use.

### BRIEF DESCRIPTION OF THE DRAWINGS

FIG. 1 is a diagrammatic view of an aerosol generating system with an aerosol generating device and an aerosol generating article;

FIG. 2 is a diagrammatic perspective view of the aerosol generating article of FIG. 1;

FIG. 3 is a diagrammatic side view of the aerosol generating article of FIG. 1 showing an aerosol precursor section and a cooling section;

FIG. 4 is a diagrammatic top view of the aerosol generating article of FIG. 1 showing the aerosol precursor section and the cooling section;

FIG. 5 is a diagrammatic cross section view of the aerosol generating system of FIG. 1 where a first aerosol generating article is received in the aerosol generating device;

FIG. 6 is a diagrammatic cross section view along line A-A of FIG. 5;

FIG. 7 is a diagrammatic cross section view of the aerosol generating system of FIG. 1 where a second aerosol generating article is received in the aerosol generating device;

FIG. 8 is a diagrammatic cross section view along line B-B of FIG. 7;

FIG. 9 is a diagrammatic cross section view of the aerosol generating system of FIG. 1 where a third aerosol generating article is received in the aerosol generating device;

FIG. 10 is a diagrammatic cross section view along line C-C of FIG. 9;

FIG. 11 is a diagrammatic cross section view of the aerosol generating system of FIG. 1 where a fourth aerosol generating article is received in the aerosol generating device;

FIG. 12 is a diagrammatic cross section view along line D-D of FIG. 11;

FIG. 13 is a diagrammatic perspective view of a fifth aerosol generating article;

FIG. 14 is a diagrammatic cross section view of the aerosol generating system of FIG. 1 where a sixth aerosol generating article is received in the aerosol generating device;

FIG. 15 is a diagrammatic cross section view along line E-E of FIG. 14;

FIG. 16 is a diagrammatic cross section view of the aerosol generating system of FIG. 1 where a seventh aerosol generating article is received in the aerosol generating device; and

FIG. 17 is a diagrammatic cross section view along line F-F of FIG. 16.

### DETAILED DESCRIPTION OF EMBODIMENTS

Embodiments of the present disclosure will now be described by way of example only and with reference to the accompanying drawings.

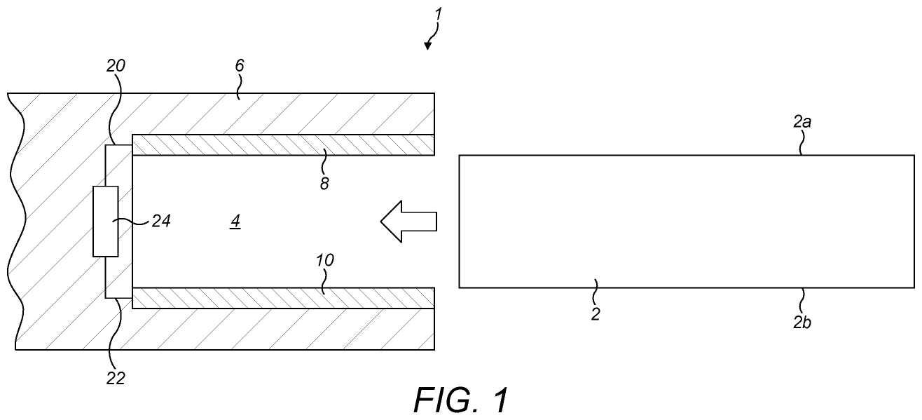

Referring initially to FIG. 1, there is shown diagrammatically an example of an aerosol generating system 1 that includes an aerosol generating article 2 (or consumable) that is adapted to be received in an aerosol generating space or heating chamber 4 of an aerosol generating device 6.

The aerosol generating device 6 includes a positive electrode 8 and a negative electrode 10 adjacent the aerosol generating space 4. The positive and negative electrodes 8, 10 may be formed from any suitable electrically conductive material such as aluminium, for example.

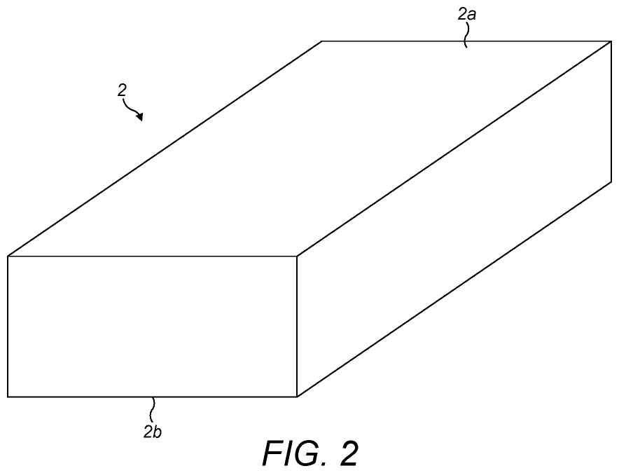

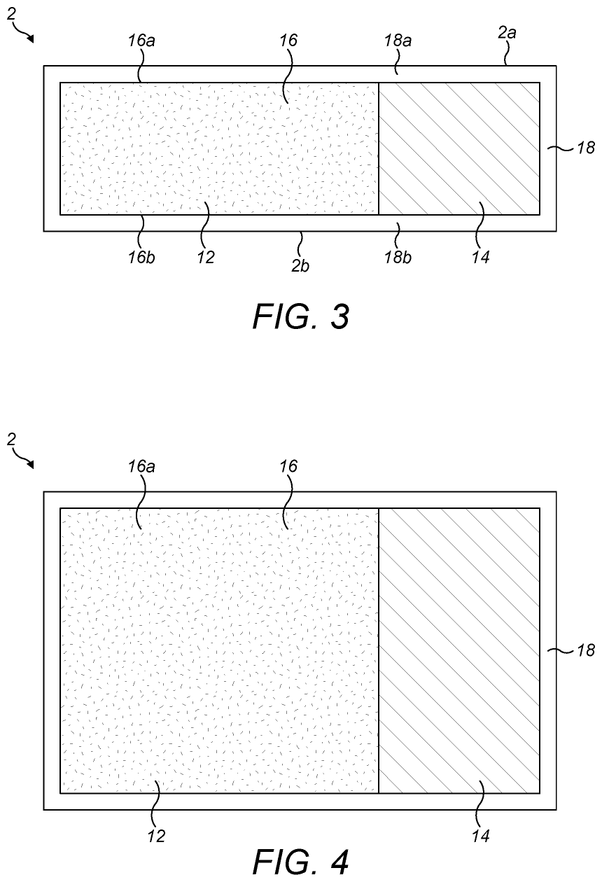

As shown in FIGS. 1 to 4, the aerosol generating article 2 has a substantially cuboid construction and includes a first outer surface 2a and a second outer surface 2b opposite the first outer surface 2a. The first and second outer surfaces 2a, 2b are the surfaces of the cuboid with the largest surface area so as to maximise the capacitance—see below. Maximising the capacitance may improve the efficiency of aerosol generation.

The aerosol generating article 2 includes an aerosol precursor section 12 and a cooling section 14 at a proximal end. The aerosol precursor section 12 includes a cuboid of aerosol generating material 16 with a first outer surface 16a and a second outer surface 16b opposite the first outer surface 16a. When heated, the aerosol generating material 16 may release one or more volatile compounds. The volatile compounds may include nicotine or flavour compounds such as tobacco or other flavouring. At least the aerosol precursor section 12 is surrounded by a wrapper 18 such as a paper wrapper so that the user does not directly touch the aerosol generating material 16 in view of sanitary requirements. In the aerosol generating article 2 as shown, the wrapper 18 extends around the outer surfaces of the aerosol generating material 16 such that the material is completely enclosed by the wrapper and the adjacent cooling section 14 of the aerosol generating article 2. The wrapper 18 also extends around the cooling section 14.

The wrapper 18 defines a first electrically non-conductive layer 18a adjacent the first outer surface 16a of the aerosol generating material 16 and a second electrically non-conductive layer 18b adjacent the second outer surface 16b of the aerosol generating material 16 if the wrapper 18 is non-conductive.

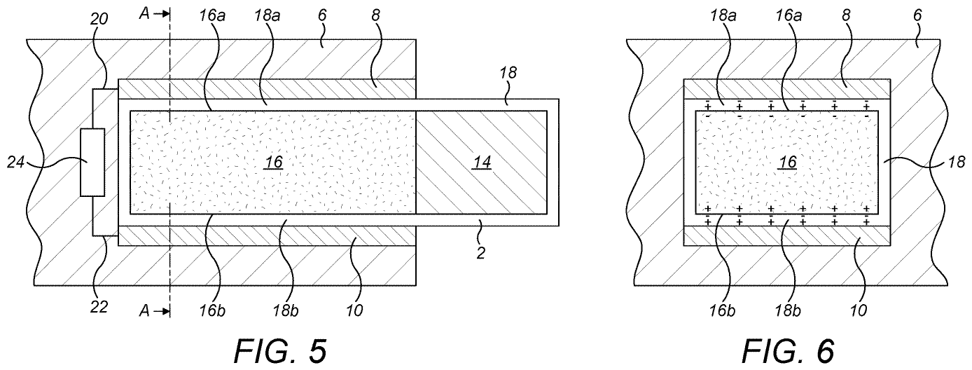

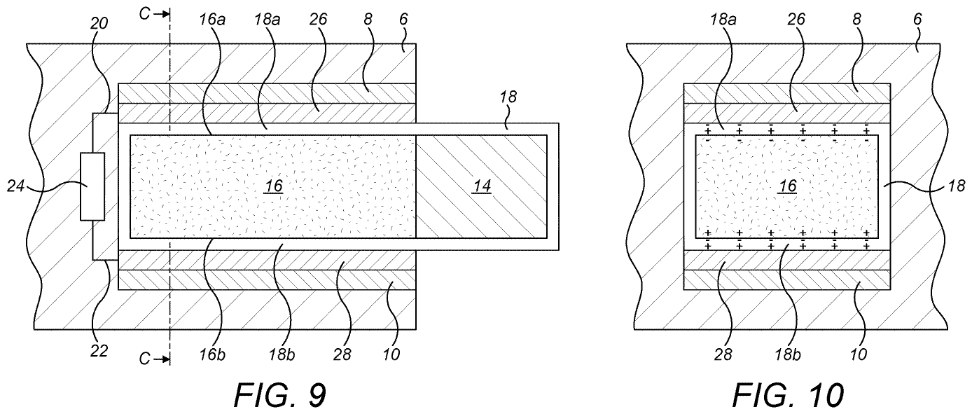

As shown in FIGS. 5 to 12 and 14 to 17, when the aerosol generating article 2 is received in the aerosol generating space 4 of the aerosol generating device 6, the positive electrode 8 is positioned adjacent the first electrically non-conductive layer 18a and the negative electrode 10 is positioned adjacent the second electrically non-conductive layer 18b. In the case of the aerosol generating system shown in FIGS. 9 to 12, it will be noted that the positive and negative electrodes 8, 10 are not directly adjacent the first and second electrically non-conductive layers 18a, 18b, but are separated from the first and second electrically non-conductive layers 18a, 18b by first and second electrically conductive layers 26, 28 that are described in more detail below. At least a part of the cooling section 14 is positioned outside the aerosol generating space 4 when the aerosol generating article 2 is received in the aerosol generating device 6 such that the positive and negative electrodes 8, 10 do not over overlap with the cooling section.

The electrodes 8, 10 are substantially planar and define a pair of electrically conductive parallel capacitor plates that are separated by a dielectric that includes the first and second electrically non-conductive layers 18a, 18b. In the arrangement shown in FIGS. 5 and 6 the aerosol generating material 16 is an electrically non-conductive material (e.g., a plant derived material, and in particular a tobacco material) and the dielectric therefore also includes the aerosol generating material. The aerosol generating system 1 is constructed generally as a capacitor.

The positive electrode 8 has a surface area substantially the same as the surface area of the first outer surface 16a of the aerosol generating material 16. The negative electrode 10 has a surface area substantially the same as the surface area of the second outer surface 16b of the aerosol generating material 16. Alternatively, the positive electrode 8 has a larger surface area than the surface area of the first outer surface 16a of the aerosol generating material 16 and/or the negative electrode 10 has a larger surface area than the surface area of the second outer surface 16b of the aerosol generating material 16. This may provide secure contact between the positive electrode 8 and the first outer surface 16a and/or the negative electrode 10 and the second outer surface 16b even if the aerosol generating article 2 is not completely inserted into the aerosol generating space 4.

The positive electrode 8 is connected to a positive terminal 20 and the negative electrode 10 is connected to a negative terminal 22. The aerosol generating device 6 includes a circuit 24 electrically connected between the positive and negative terminals 20, 22 with a power source (not shown) and a switching device (not shown) that is closed to charge the capacitor and opened to discharge the capacitor. When a voltage is applied across the positive and negative terminals 20, 22 to charge the capacitor, a net positive charge will collect on the positive electrode 8 and a net negative charge will collect on the negative electrode 10. An electric field is generated between the positive and negative electrodes 8, 10. The capacitor may be charged until its voltage value is substantially equal to the voltage across the positive and negative electrode 8, 10. If the capacitor is fully charged, the current will stop flowing in the circuit 24. The capacitor may be discharged, e.g., through a resistor that forms part of the circuit 24. Charging and discharging the capacitor heats the aerosol generating material 16 to generate an aerosol for inhalation by a user.

Charging and discharging the capacitor dissipates heat in the positive and negative electrodes 8, 10, which heats the adjacent aerosol generating material 16. When the capacitor is charged, i.e., when an electric field is generated between the positive and negative electrodes 8, 10, the aerosol generating material 16 is polarised such that positive charges within the aerosol generating material (and the first and second electrically non-conductive layers 18a, 18b) are displaced slightly in the direction of the electric field, and the negative charges are displaced slightly in the direction opposite to the electric field. The polarisation is released when the capacitor is discharged and the charges may revert to their original positions. The moving positive and negative charges interact with the internal resistance of the aerosol generating material 16 to provide direct heating of the aerosol generating material. In FIGS. 6, 8, 10, 12, 15 and 17, polarisation of the individual dielectric layers during capacitor charging is indicated by the positive and negative signs (“+” and “−”).

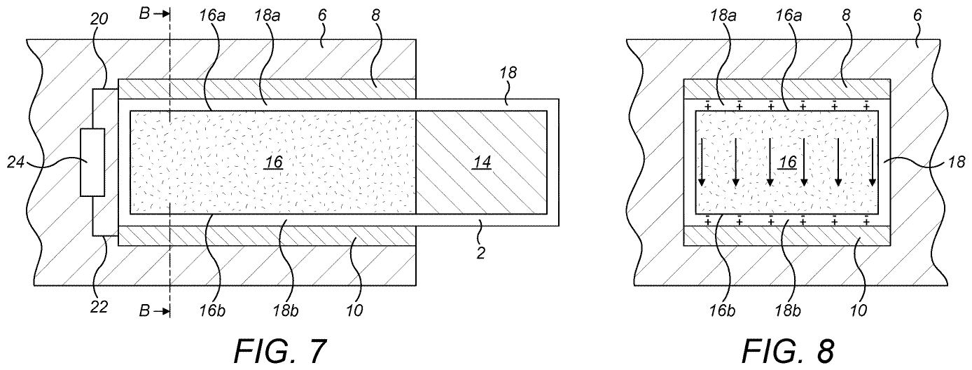

In the arrangement shown in FIGS. 7 and 8, the aerosol generating material 16 is an electrically conductive material (e.g., a plant derived material, and in particular a tobacco material, as a substrate that is doped with an electrically conductive material such as a carbon-based material or metal particles to make it electrically conductive). The first electrically non-conductive layer 18a functions as a first dielectric between the positive electrode 8 and the aerosol generating material 16. The second electrically non-conductive layer 18b functions as a second dielectric between the aerosol generating material 16 and the negative electrode 10. When the capacitor is charged, the electric field that is generated between the positive and negative electrodes 8, 10 will cause an electric current to flow through the aerosol generating material 16. When the capacitor is discharged, an electric current will flow through the aerosol generating material 16 in the opposite direction. Because of the internal resistance of the aerosol generating material 16, the electric current that flows through the aerosol generating material when the capacitor is charged and discharged provides direct heating of the aerosol generating material by Joule heating. In FIGS. 8, 12 and 17, current flow during capacitor charging is indicated by the vertical arrows. The first and second electrically non-conductive layers 18a, 18b are polarised by the electric field such that positive charges within the layers are displaced slightly in the direction of the electric field and negative charges are displaced slightly in the direction opposite to the electric field.

In both of these arrangements, direct heating is provided without having to expose part of the aerosol generating material 16. There is no risk that the fingers of the user will come into contact with exposed aerosol generating material 16, nor that some of the aerosol generating material will escape from the aerosol generating article 2.

In the arrangements shown in FIGS. 9 to 13, the aerosol generating article 2 further comprises a first electrically conductive layer 26 (e.g., a first aluminium layer) positioned between the outer surface of the first electrically non-conductive layer 18a and the positive electrode 8. Similarly, the aerosol generating article 2 further comprises a second electrically conductive layer 28 (e.g., a second aluminium layer) positioned between the outer surface of the second electrically non-conductive layer 18b and the negative electrode 10. When the aerosol generating article 2 is received in the aerosol generating device 6 as shown in FIGS. 9 to 12, the first electrically conductive layer 26 is in electrical contact with the positive electrode 8 and the second electrically conductive layer 28 is in electrical contact with the negative electrode 10. The first and second electrically conductive layers 26, 28 provide increased heating of the aerosol generating material when the capacitor is charged and discharged. Because the first and second electrically conductive layers 26, 28 function as positive and negative electrodes that directly face the aerosol generating material 16 they increase the available capacitance. The positive electrode 8 and the first electrically conductive layer 26 may function as a single positive electrode assembly and the negative electrode 10 and the second electrically conductive layer 28 may function as a single negative electrode assembly. In these embodiments, complete insertion of the aerosol generating article 2 into the aerosol generating space 4 and complete contact between the aerosol generating article 2 and the positive and negative electrodes 8, 10 is no longer required to maximise the available capacitance. This may make it easier for the user to use the aerosol generating system 1. More particularly, in these embodiments the positive electrode 8 does not need to have a surface area that is larger than or the same as the surface area of the first outer surface 16a of the aerosol generating material 16 and/or the negative electrode 10 does not need to have a surface area that is larger than or the same as the surface area of the second outer surface 16b of the aerosol generating material 16. A narrower or smaller positive and/or negative electrode may therefore be used. This may mean that the positive and/or negative electrodes 8, 10 are not exposed at the proximal end of the aerosol generating device 6. It may also prevent the transfer of electrostatic charge from the user to the positive and/or negative electrodes 8, 10.

In the arrangement shown in FIGS. 9 and 10, the aerosol generating material 16 is an electrically non-conductive material. The aerosol generating material 16 and the first and second electrically non-conductive layers 18a, 18b function as a dielectric between the positive and negative electrode assemblies (i.e., as defined respectively by the positive electrode 8 and the first electrically conductive layer 26 and the negative electrode 10 and the second electrically conductive layer 28). Charging and discharging the capacitor dissipates heat in the positive and negative electrodes 8, 10 and the first and second electrically conductive layers 26, 28, which heats the adjacent aerosol generating material 16. The aerosol generating material 16 is also heated by the interaction of the moving positive and negative charges with the internal resistance of the aerosol generating material as described above when the aerosol generating material (and the first and second electrically non-conductive layers 18a, 18b) are polarised by the electric field and when the polarisation is released.

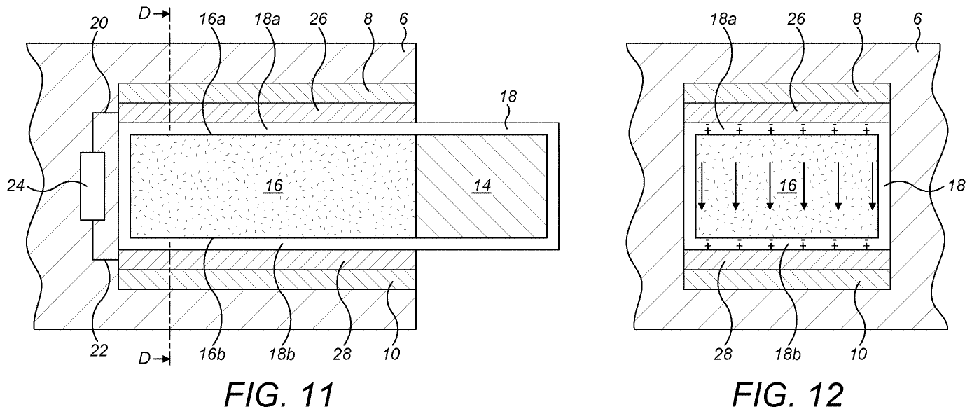

In the arrangement shown in FIGS. 11 and 12, the aerosol generating material 16 is an electrically conductive material. The first electrically non-conductive layer 18a functions as a first dielectric between the positive electrode assembly (i.e., as defined by the positive electrode 8 and the first electrically conductive layer 26) and the aerosol generating material 16. The second electrically non-conductive layer 18b functions as a second dielectric between the aerosol generating material 16 and the negative electrode assembly (i.e., as defined by the negative electrode 10 and the second electrically conductive layer 28). When the capacitor is charged, the electric field that is generated between the positive and negative electrode assemblies will cause an electric current to flow through the aerosol generating material 16. In particular, once a voltage is applied across the first and second terminals 20, 22, the first and second electrically non-conductive layers 18a, 18b are polarised. Such polarisation of the first and second electrically non-conductive layers 18a, 18b causes an electric field to be generated across the aerosol generating material 16, which in turn causes an electric current to flow through the aerosol generating material. When the capacitor is discharged, an electric current will flow through the aerosol generating material 16 in the opposite direction. Because of the internal resistance of the aerosol generating material 16, the electric current that flows through the aerosol generating material when the capacitor is charged and discharged provides direct heating of the aerosol generating material by Joule heating.

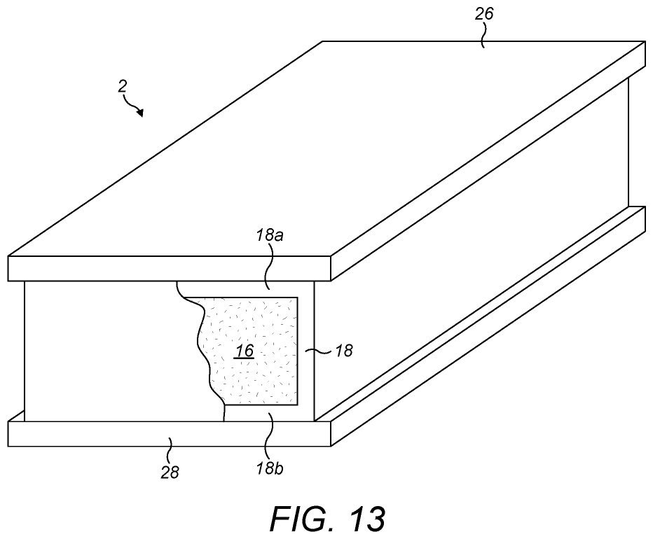

As shown in FIG. 13, a surface area of the first electrically conductive layer 26 may be larger than the surface area of the outer surface of the first electrically non-conductive layer 18a. A surface area of the second electrically conductive layer 28 may be larger than the surface area of the outer surface of the second electrically non-conductive layer 18b. Making the first and second electrically conductive layers 26, 28 slightly larger than the corresponding outer surfaces of the aerosol generating material 16 and the first and second electrically non-conductive layers 18a, 18b may increase available capacitance while also accommodating manufacturing tolerances.

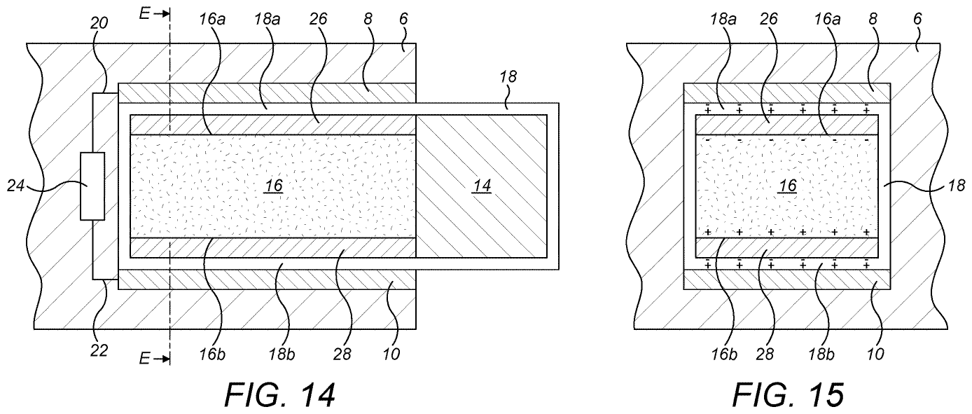

In the arrangements shown in FIGS. 14 to 17, the aerosol generating article 2 further comprises a first electrically conductive layer 26 (e.g., a first aluminium layer) positioned between the first outer surface 16a of the aerosol generating material 16 and the inner surface of the first electrically non-conductive layer 18a. Similarly, the aerosol generating article 2 further comprises a second electrically conductive layer 28 (e.g., a second aluminium layer) positioned between the second outer surface 16b of the aerosol generating material 16 and the inner surface of the second electrically non-conductive layer 18b. In this arrangement, the first and second electrically conductive layers 26, 28 are positioned within the wrapper 18, which may make the aerosol generating article 2 more suitable for the user. For example, the user does not need to directly touch the first and second electrically conductive layers 26, 28 and so any electrical interaction with the user (e.g., static electricity shock) is avoided. The first and second electrically conductive layers 26, 28 are also protected by the wrapper 18. The wrapper 18 may prevent the first and second electrically conductive layers 26, 28 from being damaged or becoming dirty, which may result in a reduction in the available capacitance.

In the arrangement shown in FIGS. 14 and 15, the aerosol generating material 16 is an electrically non-conductive material. The first electrically non-conductive layer 18a functions as a first dielectric between the first electrode 8 and the first electrically conductive layer 26. The second electrically non-conductive layer 18b functions as a second dielectric between the second electrically conductive layer 28 and the second electrode 10. The aerosol generating material 16 functions as a third dielectric between the first and second electrically conductive layers 26, 28. When the capacitor is charged, the electric field that is generated between the first and second electrodes 8, 10 will cause polarisation of the aerosol generating material 16. In particular, once a voltage is applied across the first and second terminals 20, 22, the first and second electrically non-conductive layers 18a, 18b are polarised. The first and second electrically non-conductive layers 18a, 18b charge the first and second electrically conductive layers 26, 28, which then function respectively as positive and negative electrodes that directly face the aerosol generating material 16. The aerosol generating material 16 is then polarised by the first and second electrically conductive layers 26, 28. When the capacitor is discharged, polarisation of the aerosol generating material 16 is released. Charging and discharging the capacitor dissipates heat in the first and second electrodes 8, 10 and the first and second electrically conductive layers 26, 28, which heats the adjacent aerosol generating material 16. The aerosol generating material 16 is also heated by the interaction of the moving positive and negative charges with the internal resistance of the aerosol generating material as described above when the aerosol generating material (and the first and second electrically non-conductive layers 18a, 18b) are polarised by the electric field and when the polarisation is released.

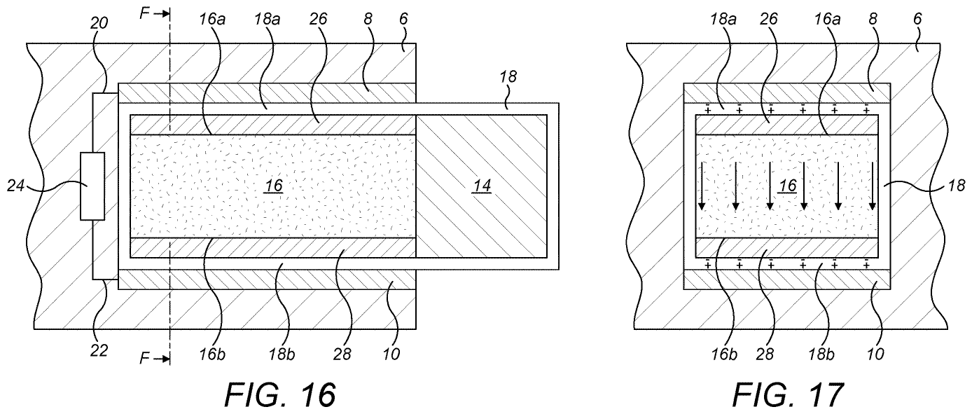

In the arrangement shown in FIGS. 16 and 17, the aerosol generating material 16 is an electrically conductive material. The first electrically non-conductive layer 18a functions as a first dielectric between the first electrode 8 and the first electrically conductive layer 26. The second electrically non-conductive layer 18b functions as a second dielectric between the second electrically conductive layer 28 and the second electrode 10. The first and second electrically conductive layers 26, 28 are in electrical contact with the aerosol generating material 16 and they function as an electrically conductive layer between the first and second electrically non-conductive layers 18a, 18b. When the capacitor is charged, the electric field that is generated between the first and second electrodes 8, 10 will cause an electric current to flow through the first and second electrically conductive layers 26, 28 and the aerosol generating material 16, which provides direct heating of the aerosol generating material by Joule heating. In particular, once a voltage is applied across the first and second terminals 20, 22, the first and second electrically non-conductive layers 18a, 18b are polarised. The first and second electrically non-conductive layers 18a, 18b charge the first and second electrically conductive layers 26, 28, which then function respectively as positive and negative electrodes that directly face the aerosol generating material 16 and apply an electric field across the aerosol generating material. When the capacitor is discharged, an electric current will flow through the first and second electrically conductive layers 26, 28 and the aerosol generating material 16 in the opposite direction.

Although exemplary embodiments have been described in the preceding paragraphs, it should be understood that various modifications may be made to those embodiments without departing from the scope of the appended claims. Thus, the breadth and scope of the claims should not be limited to the above-described exemplary embodiments.

Any combination of the above-described features in all possible variations thereof is encompassed by the present disclosure unless otherwise indicated herein or otherwise clearly contradicted by context.

Unless the context clearly requires otherwise, throughout the description and the claims, the words “comprise”, “comprising”, and the like, are to be construed in an inclusive as opposed to an exclusive or exhaustive sense; that is to say, in the sense of “including, but not limited to”.

1. An aerosol generating system comprising:
aerosol generating material with a first outer surface and a second outer surface substantially opposite the first outer surface;
a first electrically non-conductive layer adjacent the first outer surface, wherein the first electrically non-conductive layer has an inner surface and an outer surface;
a second electrically non-conductive layer adjacent the second outer surface;
a first electrode adjacent to the first electrically non-conductive layer; and
a second electrode adjacent to the second electrically non-conductive layer;
wherein the aerosol generating material and the first and second electrically non-conductive layers are part of an aerosol generating article comprising a first electrically conductive layer positioned between the first outer surface of the aerosol generating material and the inner surface of the first electrically non-conductive layer.

2. The aerosol generating system according to claim 1, wherein the second electrically non-conductive layer has an inner surface and an outer surface, and wherein the aerosol generating article further comprises a second electrically conductive layer positioned between the second outer surface of the aerosol generating material and the inner surface of the second electrically non-conductive layer.

3. The aerosol generating system according to claim 1, wherein the aerosol generating material is part of an aerosol precursor section of the aerosol generating article and the aerosol generating article further comprises a cooling section at a proximal end, and the first and second electrodes do not overlap with the cooling section.

4. The aerosol generating system according to claim 1, wherein the first and second electrodes are part of an aerosol generating device adapted to receive, in use, the aerosol generating article, wherein the aerosol generating device further comprises a circuit electrically connected between the first and second electrodes, the circuit comprising a power source and a switching device.

5. The aerosol generating system according to claim 1, wherein the aerosol generating material comprises a tobacco material.

6. The aerosol generating system according to claim 1, wherein the aerosol generating material is electrically conductive.

7. The aerosol generating system according to claim 1, wherein the aerosol generating material is substantially cuboid and the first and second outer surfaces are the surfaces of the cuboid with the largest surface area.

8. The aerosol generating system according to claim 1, wherein the first and second electrically non-conductive layers are formed by a wrapper that extends substantially around the aerosol generating material.

9. An aerosol generating article comprising:
aerosol generating material with a first outer surface and a second outer surface opposite the first outer surface; and
an electrically non-conductive wrapper that extends substantially around the aerosol generating material and defines a first electrically non-conductive layer adjacent the first outer surface and a second electrically non-conductive layer adjacent the second outer surface;
wherein the first electrically non-conductive layer has an inner surface and an outer surface, and wherein the aerosol generating article further comprises a first electrically conductive layer positioned between the first outer surface of the aerosol generating material and the inner surface of the first electrically non-conductive layer.

10. The aerosol generating article according to claim 9, wherein the second electrically non-conductive layer has an inner surface and an outer surface, and wherein the aerosol generating article further comprises a second electrically conductive layer positioned between the second outer surface of the aerosol generating material and the inner surface of the second electrically non-conductive layer.

11. The aerosol generating article according to claim 9, wherein the aerosol generating material comprises a tobacco material.

12. The aerosol generating article according to claim 9, wherein the aerosol generating material is electrically conductive.

13. The aerosol generating article according to claim 9, wherein the aerosol generating material is substantially cuboid and the first and second outer surfaces are the surfaces of the cuboid with the largest surface area.

14. An aerosol generating device adapted to receive, in use, the aerosol generating article according to claim 10, the device comprising a first electrode adjacent the first electrically non-conductive layer in use and a second electrode adjacent the second electrically non-conductive layer in use.

15. The aerosol generating device according to claim 14, further comprising a circuit electrically connected between the first and second electrodes, the circuit comprising a power source and a switching device.
